(19) United States
(12) Patent Application Publication
(10) Pub. No.: US 2022/0120118 A1
(43) Pub. Date: Apr. 21, 2022

(54) LOCKING DEVICE TO LOCK AND/OR UNLOCK A MOVABLE CLOSURE ELEMENT IN A LOCKABLE OBJECT, ESPECIALLY A DOOR, A LID, ETC.

(71) Applicants: INTEVA FRANCE SAS, Sully Sur Loire (FR); Marquardt GmbH, Rietheim-Weilheim (DE)

(72) Inventors: Andreas BECHER, Villingen-Schwenningen-Obereschach (DE); Oliver HUPPENBAUER, Villingen-Schwenningen-Obereschach (DE); Daniel LOPEZ, Villingen-Schwenningen-Obereschach (DE); Jean-Marc BELMOND, Saint-Jean Le Blanc (FR); Pascal PHILIPPE, Saulcy / Meurthe (FR)

(21) Appl. No.: 17/515,106

(22) Filed: Oct. 29, 2021

Related U.S. Application Data
(63) Continuation of application No. PCT/IB2019/000412, filed on Apr. 30, 2019.

(51) Int. Cl. E05B 81/86; E05B 81/20; E05F 15/70

(52) U.S. Cl. CPC E05B 81/86; E05B 81/20; E05F 15/70; E05Y 2900/531; E05Y 2400/612; E05Y 2900/132; E05Y 2201/22

(57) ABSTRACT

A locking device is proposed to lock and/or to unlock a movable closure element like a door, a lid, etc. in a lockable object like a building, a ship, a vehicle, a train or the like, wherein the locking device has an electric control unit and/or a drive unit to control and/or to drive a movement of the movable closure element. The locking device shall be usable in applications without a handle for manual movements and is working with disconnected regular power supply. According to the invention, at least one supercapacitor is provided to store energy for operating the locking device in an emergency case.

In the locking systems for doors in lockable objects like cars, buildings, etc. the authorization to enter and operate the door transmitters and receivers are commonly used, to allow a keyless entry and operation. Electric motor components are used for the necessary movements of the mechanical latching components.

These systems increase the comfort during the regular operation of the object. Nevertheless they must work also in the emergency case i.e. if the power supply for the locking system is damaged for example by an accident or a defect of the power supply. For this reason in the locking system for a car of the WO 2016/177767 A1 an emergency battery is provided. Although the latching and/or unlatching is operated automatically, the car door is moved manually by pulling a handle or the like. The power supply of such an emergency battery is not able to supply opening systems having an increased power consumption like automatic opening drives.

Suppressing the possibility to open closure elements like a door by use of a traditional mechanical handle in combination with a key and a cylinder makes the system non-operating, if the power source, for example the car battery, is disconnected from the locking device, since an emergency battery cannot supply the required power for an automatic opening movement of such closure elements like doors. This will be Particularly required with the coming E-cars that, for safety reasons, must disconnect in a crash situation the huge power source, Traditional cars also experienced sometimes a discharged or defect 12V battery. A vehicle should remain closed during a crash, but it is not possible to release the E latch if the power source is switched-off. Also in other objects like buildings, trains, etc. the closure elements are or will be constructed without handles because of functional or design reasons.

The object of this invention is to provide a locking device, which is usable in applications without such a handle for manual movements and is working with disconnected regular power supply.

Starting from a locking device according to the preamble of claim 1 this is achieved by the characterizing features of claim 1.

Accordingly there is provided at least one supercapacitor to store energy for operating the locking device in an emergency case.

One or more supercapacitors are able to store a high energy amount, to unlock, release and/or move a movable closure element like a door in a lockable object like a building, a train, a ship, a car, etc. during a time slot till one hour. The benefit of a supercapacitor is that it can store a high energy amount, is not restricted in loading cycles and can deliver a high current. So beside the locking or releasing function an additional drive for an opening movement of the closure element can be supplied.

Advantageously the at least one supercapacitor is connected as power supply to the electric control unit and/or the drive unit in the emergency case to allow the controlled and driven emergency operation of the locking device.

Preferably the at least one supercapacitor is located on a printed circuit board and/or inside a housing of the electric control unit and/or the drive unit. This arrangement allows short conductive connections between the supercapacitor or supercapacitors and the corresponding control unit and/or drive unit. So the risk of a damage of this connection i.e. an accident is minimized. Additionally a short conductor line reduces the electric resistance and a corresponding power loss.

For the same reasons it is an advantage, if the supercapacitor and the control unit and the drive unit are located on the same printed circuit board and/or inside the same housing.

A movement of a driven closure element of a lockable object as a door of a building, a train, a ship, a car, etc. enables the setting of this closure element in an operation position, in which for example an operator can grip beside or behind the closure element to pull it open. An automatic controlled and driven closure movement can be useful even in the emergency case to close the car for protection reasons. So preferably the control unit controls and the drive unit drives a locking operation and/or an unlocking operation and/or an opening movement and/or a closing movement of the closure element

To make sure that in any required situation the supercapacitor is sufficiently charged and operational the at least one supercapacitor is connected with a charge contact of a DC/DC converter and/or an AC/DC converter, which is connected to a regular power supply of the lockable object, preferably to a regular battery or power line of the lockable object, which is used for the regular operation of the closure element and/or the lockable object.

If the lockable object i.e. a train, a ship, a car, etc. has an ignition battery to start an engine, it is advantageously used as regular battery for charging the at least one supercapacitor, since normally the ignition battery is charged by the engine during operation and able to charge the at least one supercapacitor the ignition battery of the lockable object.

For a controlling of the charging process preferably a voltmeter is provided to measure the voltage at the charge contact of the supercapacitor.

A good charge status of the at least one supercapacitor control can be ensured, when the control unit is adopted to activate a low power consumption mode for the locking device if the voltage at the charge contact falls below a defined threshold. This low power consumption mode extends the operation time, during which the emergency function is working after an interruption of the charging power supply.

This operation time can be extended additionally, if a separate emergency battery is provided for a charging connection to the supercapacitor.

The functional safety is further enhanced, when the emergency battery is located on a printed circuit board and/or inside a housing of the control unit and/or the drive unit preferably on the printed circuit board and/or housing of the control unit and/or the drive unit according to claim 3 or 4. Short connection lines to the control unit, the drive unit to the supercapacitor decreases the risk of defects and ensures the emergency function of the locking device.

A further improvement is realized, if the control unit and/or the drive unit, and/or the locking device in total is located on or inside the closure element, preferably a door of the lockable object. This placement facilitates the access to the locking device, i.e. for repairing purposes.

Advantageously a monitoring device to monitor the status of the emergency battery and/or a manual access to change the emergency battery is provided. So not only the charge status of the at least one supercapacitor, but additionally the status of the emergency battery are monitored and a warning is possible if there is a possibility of malfunction.

A further enhancement of the invention is possible, if the control unit is adopted to connect the at least one supercapacitor automatically to the emergency battery, when the low power consumption mode is activated. So the emergency battery is preserved during regular operation of the car, but activated, when the power supply to the supercapacitors is disturbed.

Preferably the control unit is adopted to control a charging mode for the at least one supercapacitor. So the monitoring data of the control unit can immediately be used for the charge controlling.

One method for controlling the charging of the at least one supercapacitor is to define two voltage thresholds for the charging mode in the control unit, wherein the control unit is adopted to start the charging if the voltage at the supercapacitor falls below a lower threshold and stopped when the voltage of the supercapacitor exceeds a upper threshold.

Some embodiments of the invention are illustrated in the following drawings.

Especially show

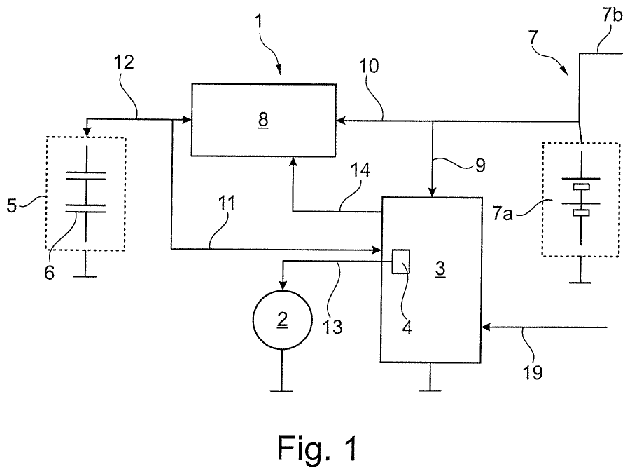

FIG. 1 a schematic diagram of an electric arrangement according to the invention,

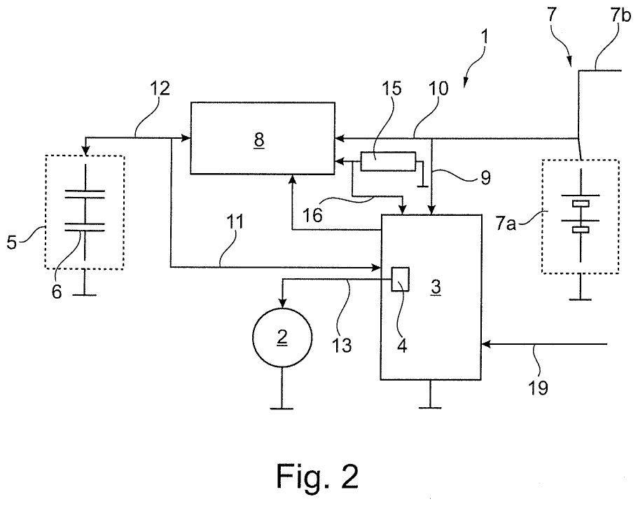

FIG. 2 a diagram of the embodiment according FIG. 1 with an additional emergency battery,

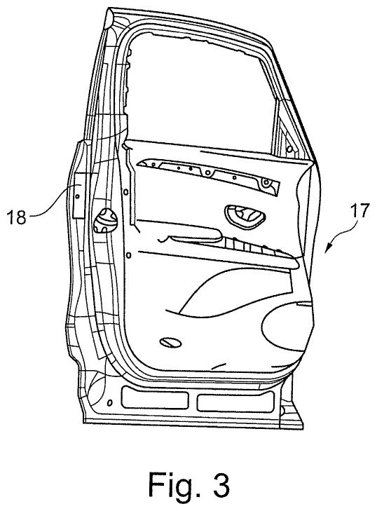

FIG. 3 a door of a car, in which the locking device can be placed and

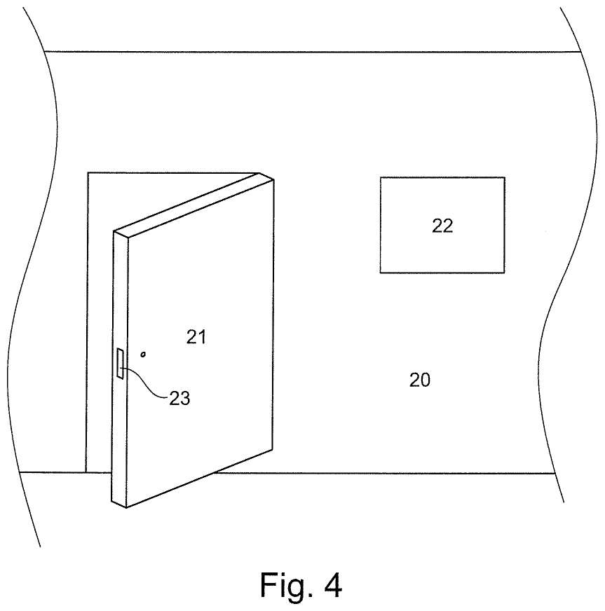

FIG. 4 a door of a car, in which the locking device can be placed.

FIG. 1 shows a locking device 1 comprising a motor 2, a control unit 3 including a drive unit 4 and a bank 5 of supercapacitors 6. A regular power supply 7 of the lockable object, i.e. an regular battery 7a or a regular power line 7b, is connected to the bank 5 of supercapacitors 6 via a DC/DC or an. AC/DC converter 8. If necessary more motors 2 can be provided for a door release and/or driving.

Via an input line 9 the control unit 3 is connected to an input line 10, which supplies the DC/DC or AC/DC converter 8 with the regular operation power. Via an input line 11 the control unit 3 is connected to a line 12 between the DC/DC converter and the bank 5 of supercapacitors 6.

A drive line 13 connects the drive unit 4 with the motor 2 and a bus line 19 connects the control unit 3 with a car bus system a CAN Bus. A control line 14 connects the control unit 3 with the DC/DC or AC/DC converter 8.

In the regular operation mode the supercapacitors 6 are charged by the regular power supply 7 and the DC/DC or AC/DC converter 8, which prepares the appropriate charge voltage. The control unit 3 is able to monitor the voltage of the power supply 7 via the input line 9. The DC/DC or ACDC converter 8 is controlled by the control unit 3 via the control line 14. The charge voltage of the supercapacitors 6 is monitored by the control unit 3 via the input line 11.

To optimally use the capacity of the supercapacitors 6, the system proposed here keeps the voltage across the bank 5 of capacitors 6 constant. Even if the power source of the power supply 7 is increasing or decreasing, the charge of the supercapacitors will always be the same. By missing power source the control unit 3 will enter in a very low power consumption mode allowing the supercapacitors 6 to keep most of the charge available for a large time interval.

The charge is enough to perform access recognition, validation and perform unlock and drive the motor 2 at least two times.

The embodiment according FIG. 2 shows an additional emergency battery 15 connected to the DC/DC or AC/DC converter 8 and monitored via the input line 16 by the control unit 3. This emergency battery 15 extends the time interval for which the locking device is working in case of a crash or an interruption of the regular power supply 7 over a long time for example one or more years. Furthermore it is possible to change this battery timely, because it is monitored and the control unit 3 is able to send a message to the operator via the bus line 19.

A battery change or other service or repair actions are easy to do, when the complete locking device or at least the battery holder is placed manually accessible. For example a placement in a door 17 as shown in FIG. 3 is useful especially in a housing 18 on the narrow side of a car door.

In FIG. 4 the same situation is shown for a building. A house wall 20 with a door 21 and a window 22 is outlined having a housing for the complete locking device or at least the battery holder manually accessible.

1. Locking device

2. Motor

3. Control unit

4. Drive unit

5. Bank

6. Supercapacitor

7. Power supply

7a. Regular battery

7b. Power line

8. DC/DC or AC/DC converter

9. Input line

10. Input line

11. Input line

12. Line

13. Drive line

14. Control line

15. Emergency battery

16. Monitoring line

17. Door

18. Housing

19. Bus line

20. House wall

21. House door

22. Window

23. Housing

1-18. (canceled)

19. A locking device to lock and/or to unlock a movable closure element like a door, a lid, etc. in a lockable object like a building, a ship, a vehicle, a train or the like, wherein the locking device has an electric control unit and/or a drive unit to control and/or to drive a movement of the movable closure element, wherein at least one supercapacitor is provided to store energy for operating the locking device in an emergency case.

20. The locking device according to claim 19, wherein the at least one supercapacitor is connected as power supply to the electric control unit and/or the drive unit in the emergency case.

21. The locking device according to claim 19, wherein the at least one supercapacitor is located on a printed circuit board and/or inside a housing of the electric control unit and/or the drive unit.

22. The locking device according to claim 19, wherein the at least one supercapacitor and the control unit and the drive unit are located on the printed circuit board and/or inside the same housing.

23. The locking device according to claim 19, wherein the control unit controls and the drive unit drives a locking operation and/or an unlocking operation and/or an opening movement and/or a closing movement of the movable closure element.

24. The locking device according to claim 19, wherein the at least one supercapacitor is connected with a charge contact of a DC/DC and/or AC/DC converter, which is connected to a regular power supply of the lockable object, preferably to a regular power supply of the lockable object, which is used for the regular operation of the movable closure element and/or the lockable object.

25. The locking device according to claim 24, wherein the regular power supply is an ignition battery for an engine of the lockable object.

26. The locking device according to claim 19, wherein a voltmeter is provided to measure the voltage at a charge contact of the at least one supercapacitor.

27. The locking device according to claim 19, wherein the control unit is adopted to activate a low power consumption mode for the locking device if a voltage at a charge contact falls below a defined threshold.

28. The locking device according to claim 19, wherein a separate emergency battery is provided for a charging connection to the at least one supercapacitor.

29. The locking device according to claim 19, wherein the separate emergency battery is located on a printed circuit board and/or inside a housing of the control unit and/or the drive unit.

30. The locking device according to claim 19, wherein the control unit and/or the drive unit and/or the locking device is located on or inside the movable closure element.

31. The locking device according to claim 28, wherein a monitoring device to monitor a status of the separate emergency battery and/or a manual access to change the separate emergency battery is provided.

32. The locking device according to claim 19, wherein the control unit is adopted to connect the at least one supercapacitor automatically to the separate emergency battery, when a low power consumption mode is activated.

33. The locking device according to claim 19, wherein the control unit is adopted to control a charging mode for the at least one supercapacitor.

34. The locking device according to claim 19, wherein two voltage thresholds are defined in the control unit for a charging mode, wherein the control unit is adopted to start charging if a voltage at the at least one supercapacitor falls below a lower threshold and stopped when the voltage of the supercapacitor exceeds an upper threshold.

35. A closure element comprising a door wherein a locking device according to claim 19 is provided.

36. The closure element as in claim 35, wherein the closure element is a movable closure element.
